(19) United States
(12) Patent Application Publication
(10) Pub. No.: US 2014/0312851 A1
(43) Pub. Date: Oct. 23, 2014

(54) APPARATUS FOR PREVENTING ELECTRIC OVESTRESS IN ELECTRONIC DEVICE

(71) Applicant: SAMSUNG ELECTRONICS CO., LTD., Suwon-si (KR)

(72) Inventor: Junhyun BYUN, Gumi-si (KR)

(73) Assignee: SAMSUNG ELECTRONICS CO., LTD., Suwon-si (KR)

(21) Appl. No.: 14/255,323

(22) Filed: Apr. 17, 2014

(30) Foreign Application Priority Data
Apr. 19, 2013 (KR) 10-2013-0043501

(51) Int. Cl. H02J 7/00; H02H 9/04

(52) U.S. Cl. CPC H02J 7/0029; H02H 9/04
USPC 320/137; 361/91.1

(57) ABSTRACT

An apparatus for preventing an electric overstress in an electronic device, which is capable of protecting the electronic device from the electric overstress is provided. The apparatus includes an interface unit for connecting the electronic device to an external device, includes an electric power terminal which is included in the interface unit and includes a first electric power terminal and a second electric power terminal which are electrically separated, and an electric overstress preventing unit connected with the first and second electric power terminals.

### CROSS-REFERENCE TO RELATED APPLICATION(S)

This application claims the benefit under 35 U.S.C. §119(a) of a Korean patent application filed on Apr. 19, 2013 in the Korean Intellectual Property Office and assigned Serial number 10-2013-0043501, the entire disclosure of which is hereby incorporated by reference.

### TECHNICAL FIELD

The present disclosure to an apparatus for preventing electric overstress. More particularly, the present disclosure relates to an apparatus for preventing electric overstress of an electronic device, which is capable of protecting the electronic device from the electric overstress.

### BACKGROUND

Recently, an electronic device has been used in very different fields, and provided with various functions (e.g., a voice call function, a Short Message Service (SMS) transmission and reception function, a camera function, an audio reproducing function, a digital broadcasting service function, an E-mail service function, a location-based service function, and/or the like). Such an electronic device generally includes an interface unit for connecting the electronic device to an external device (e.g., a Travel Adapter (TA)). For example, the electronic device may be supplied with electric power from a charger connected thereto through the interface unit in order to charge a battery.

According to the related art, the interface unit generally uses a mechanical contact manner. If the external device (e.g., a charger), is connected with the interface unit in the above-mentioned manner, electric overstress such as a bounce, chattering, an inrush current, and the like may be temporarily generated. For example, the electronic device according to the related art has a problem in that electronic parts (e.g., an integrated circuit), are damaged due to the electric overstress generated when the external device is connected with the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus for preventing electric overstress in an electronic device, which is capable of preventing damage of the electronic device due to the electric overstress.

In accordance with an aspect of the present disclosure, an apparatus for preventing an electric overstress in an electronic device is provided. The apparatus includes an interface unit for connecting the electronic device to an external device, includes an electric power terminal which is included in the interface unit and includes a first electric power terminal and a second electric power terminal which are electrically separated, and an electric overstress preventing unit connected with the first and second electric power terminals.

In accordance with another aspect of the present disclosure, an electronic device is provided. The electronic device includes an interface unit to which a charger is connected, and which includes a first electric power terminal, a second electric power terminal and a ground terminal, an electric overstress preventing unit connected with the first electric power terminal and the second electric power terminal, and a charging unit connected with the second electric power terminal

As described above, the apparatus for preventing the electric overstress in the electronic device according to the present disclosure can prevent the damage of the electronic device due to the electric overstress. Therefore, the present disclosure can improve reliability of a user for the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating an electronic device and a charger according to an embodiment of the present disclosure;

FIG. 2 is a block diagram schematically illustrating a structure of an electronic device according to an embodiment of the present disclosure;

FIG. 3 is a detailed view illustrating an interface unit and an electric overstress preventing unit according to a first embodiment of the present disclosure;

FIG. 4 is a detailed view illustrating an interface unit and an electric overstress preventing unit according to a second embodiment of the present disclosure;

FIG. 5 is a detailed view illustrating an interface unit and an electric overstress preventing unit according to a third embodiment of the present disclosure; and

FIG. 6 is a view illustrating a connection of an interface unit of an external device with an interface unit of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, an electronic device may include communication functionality. For example, an electronic device may be a mobile communication terminal, a Personal Digital Association (PDA), a smartphone, a tablet Personal Computer (PC), a Portable Multimedia Player (PMP), a video phone, an e-book reader, a desktop PC, a laptop PC, a netbook PC, an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

Various embodiments of the present disclosure can protect electronic parts from an Electronic Overstress (EOS) which is momentarily generated when the electronic device is connected with an external device. In order to protect electronic parts from the EOS, various embodiments of the present disclosure have a characteristic in that an electric overstress preventing unit is interposed between separated electric power terminals after the electric power terminals of interface units through which the electronic device is connected with the external device are separated, so that electric power of the external device is directly input into electric parts after the external device is completely connected with the electronic device while the electric power of the external device is input to the electronic parts through the electric overstress preventing unit before the external device is completely connected to the electronic device. Hereinafter, a case in which a charger is connected to the electronic device will be described in detail as an example of the present disclosure.

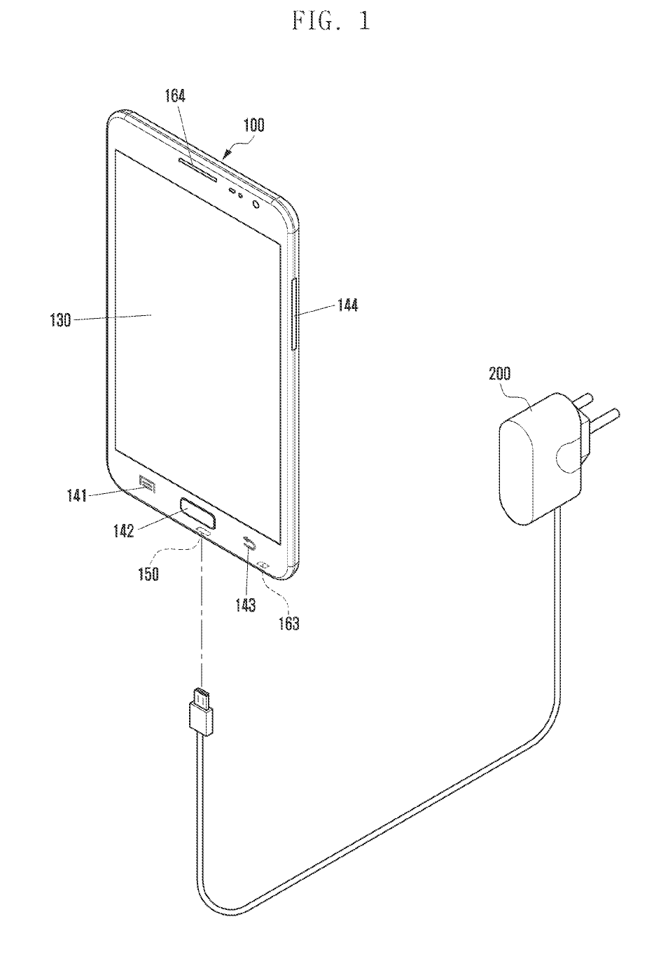

FIG. 1 is a schematic view illustrating an electronic device and a charger according to an embodiment of the present disclosure.

Referring to FIG. 1, the electronic device 100 according to the embodiment of the present disclosure may be a bar-type electronic device with a rectangular shape. The electronic device 100 may include a display unit 130 arranged on a front surface thereof, a speaker 164 arranged over the display unit 130 on the front surface thereof, a menu key 141, a home key 142, a back key 143, and/or the like which are arranged below the display unit 130 on the front surface thereof, and a volume control key 144 arranged on a side surface thereof Further, the electronic device 100 may have an interface unit 150 for connecting the charger therewith, and a microphone 163, which are arranged on a lower side surface thereof.

The charger 200 converts alternate electric current into direct electric current, and supplies the direct electric current to the electronic device 100. The charger 200 may be a Travel Adapter (TA).

The electronic device 100 can charge a battery (not shown) through the charger 200 connected to the interface unit 150 thereof According to various embodiments of the present disclosure, the electronic device 100 may include the electric overstress preventing unit (not shown). The electric overstress preventing unit may be capable of preventing (or reducing) the electric overstress (e.g., an inrush current, a bounce, chattering, and/or the like), which is momentarily generated when an interface unit of the charger 200 is connected with the interface unit 150 thereof If alternate electric current supplied to the charger 200 is unstable, occurrence frequency and magnitude of the electric overstress may further increase. The electric overstress preventing unit will be described in detail later.

Meanwhile, the electronic device 100 shown in FIG. 1 merely is an example, and does not limit the present disclosure. For example, the electronic device 100 may have different types such as a folder type, a slide type, and the like.

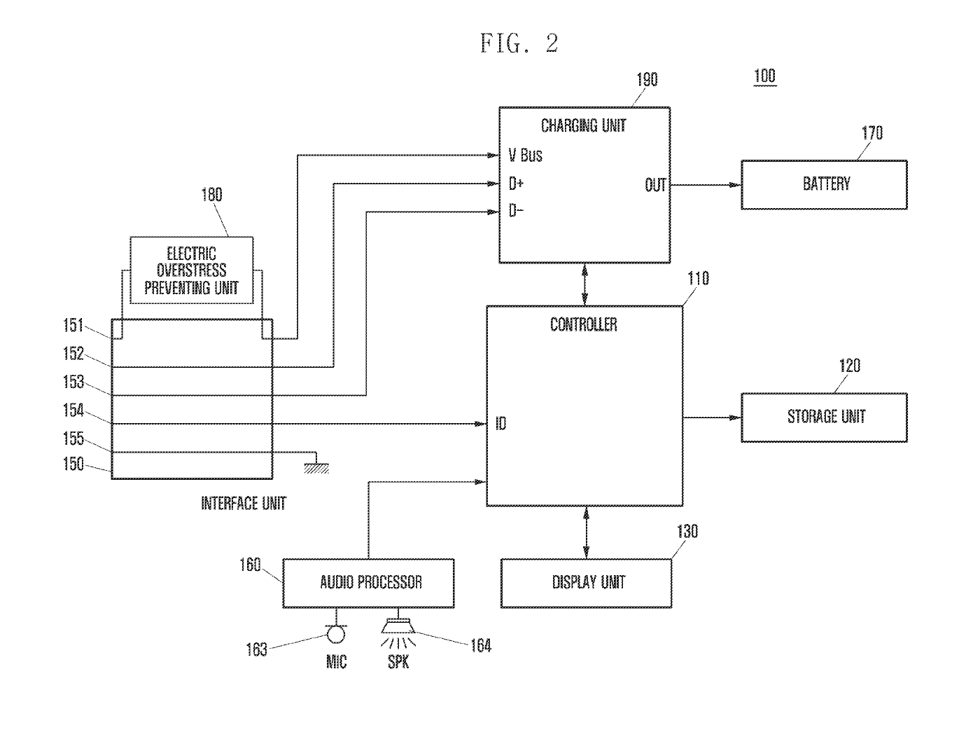

FIG. 2 is a block diagram schematically illustrating a structure of an electronic device according to an embodiment of the present disclosure.

Referring to FIGS. 1 and 2, the electronic device 100 according to the embodiment of the present disclosure may include a controller 110, a storage unit 120, a display unit 130, an interface unit 150, an audio processor 160, a battery 170, an electric overstress preventing unit 180, and a charging unit 190.

The charging unit 190 may charge the battery 170 with electric power supplied from the charger 200 connected thereto through the interface unit 150. In order to charge the battery 170, an electric terminal VBUS of the charging unit 190 may be connected to an electric terminal 151 of the interface unit 150. Further, the charging unit 190 may provide a data communication function (e.g., USB communication). In order to provide a data communication function, the charging unit 190 may include a positive data terminal D+ and a negative data terminal D−. In addition, when the charger 200 is connected to the electronic device 100, the positive data terminal D+ and the negative data terminal D− may be connected with each other. Therefore, the charging unit 190 may determine the connection of a USB cable with the charger 200, and transmits the determination result to the controller 110. For conciseness, a method of detecting the connection of the charger 200 will be omitted.

The battery 170 may supply all structural elements of the electronic device 100 with electric power. For example, such a battery 170 may be a secondary battery which is rechargeable, and which may be manufactured in various forms of a Nickel battery, a Cadmium battery, a Nickel-Cadmium battery, a chemical battery, a Lithium-Ion battery, and/or the like. The battery 170 may be charged with electric power supplied through an output terminal of the chargeable unit 190. For conciseness, a description of the battery 170 will be omitted.

The audio processor 160 may receive an input of an audio signal, or output the audio signal. For example, the audio processor 160 may receive an input of audio signals surrounding the electronic device 100 when a user communicates with a companion, or when the user carries out a recording. In order to receive the input of audio signals, the audio processor 160 may be connected to a microphone 163 for collecting a user's voice or other audio signals. Further, the audio processor 160 may output a received voice signal when the user communicates with the companion, an audio signal included in a received message, an audio signal when an audio file or a video file stored in the storage unit 120 is reproduced, and/or the like, through the speaker 164. Furthermore, the audio processor 160 may output an effective sound which informs the user of the connection of the charger 200 when detecting the connection of the charger 200, through the speaker 164.

The display unit 130 may display a graphical user interface and/or the like. For example, the display unit 130 may display various menus of the electronic device 100, information input by the user, or information to be provided to the user. For example, the display unit 130 may provide various screens according to use of electronic device 100 (e.g., a standby screen, a menu screen, a message writing screen, a voice call screen, and/or the like). Further, the display unit 130 may display a screen informing the user that the battery 170 has been charging. For example, the display unit 130 may display a preset icon informing the user of charging the battery on an indicator region. The indicator region may be an area for displaying information on a remaining amount of the battery, intensity of a received signal, and/or the like in the form of icons. Such a display unit 130 may include a Liquid Crystal Display (LCD) unit, an Organic Light Emitted Diode (OLED) unit, an Active Matrix Organic Light Emitted Diode (AMOLED) unit, and/or the like. Further, if the display unit 130 is a touch screen, the display unit 130 may carry out a function of an input unit (not shown).

The interface unit 150 may be connected with the external device. The external device may be a docking station, a Universal Serial Bus (USB) data cable, a USB charging cable, the charger 200, and/or the like.

The interface unit 150 may include an electric power terminal 151 for supplying electric power, a positive data terminal 152 for data communication, a negative data terminal 153 for data communication, an identification terminal 154 for recognizing a sort of the external device, a ground terminal 155, and/or the like. For conciseness, a description of a USB interface unit 150 will be omitted. According to various embodiments of the present disclosure, the electric power terminal 151 of the interface unit 150 may be separated into two electric power terminals, and the electric overstress preventing unit 180 may be interposed between the two separated electric power terminals. The configuration of the electric overstress preventing unit 180 will be described in detail with reference to FIGS. 3, 4 and 5 later.

FIG. 2 illustrates an interface unit 150 that includes five terminals according to a standard of a USB, a mini USB, or a micro USB. However, various embodiments of the present disclosure are not limited thereto. For example, the interface unit 150 may have different shapes and a different number of terminals according to an intention of a manufacturer of the electronic device 100.

The electric overstress preventing unit 180 may prevent the electric overstress such as a bounce, a chattering, an inrush current, and/or the like which may be momentarily generated when the charger 200 is connected with the electronic device 100. According to various embodiments of the present disclosure, the bounce or the chattering corresponds to a phenomenon in which contact points of a switch are not immediately connected with each other, but repeatedly connected and disconnected with each other due to a vibration thereof when the switch turns on or off The inrush current may refer to a phenomenon in which overcurrent temporarily flows and then normal electric current flows when the switch turns on. The electric overstress preventing unit 180 may be made of an element (e.g., a resistor), which is capable of reducing electric voltage or electric current. The electric overstress preventing unit 180 will be described with reference to FIGS. 3, 4 and 5.

The storage unit 120 may store an operating system for the electronic device 100, application programs necessary for other optional functions (e.g., an audio reproducing function, an image or video reproducing function, a broadcasting reproducing function, a communication function, and/or the like), user's data, data to be transmitted and received during communication, and/or the like. Further, the storage unit 120 may store a charging control program for controlling a charge of the battery 170.

The controller 110 may control overall operations of the electronic device 100 and a signal flow between internal blocks of the electronic device 100, and may perform a data processing function for processing data. For example, the controller 110 may be a Central Processing Unit (CPU), an application processor, and/or the like. According to various embodiments of the present disclosure, the controller 110 may have a various number of cores. For example, the controller 110 may be a single core processor, or a multi-core processor. The controller 110 may activate the charging unit 190 so as to charge the battery 170 when detecting the connection of the charger 200. Further, the controller 110 may determine a sort of the external device connected to the interface unit 150 through the identification terminal ID. Particularly, the controller 110 may determine a sort of the external device through an electric voltage input to the identification terminal ID. For conciseness, a method of determining the external device will be omitted.

Although a description of various embodiments of the present disclosure described the data communication function as being included in the charging unit 190, the data communication function may be included in another element (e.g., the controller 110). Alternatively, the electronic device 100 may include a separate module for providing the data communication function.

Further, although not shown in FIG. 2, the electronic device 100 further may selectively include structural elements for carrying out additional functions, such as a mobile communication module for a mobile communication, a wireless communication module for a wireless communication, a broadcasting receiving module for a reception of broadcasting, a digital sound source reproduction module such as an MP3 module, and/or the like. Although all structural elements cannot be listed because such structural elements may be variously modified according to the convergence trend of digital devices, according to various embodiments of the present disclosure, the electronic device 100 may further include structural elements at the equivalent level to the above listed components.

FIG. 3 is a detailed view illustrating an interface unit and an electric overstress preventing unit according to a first embodiment of the present disclosure.

Referring to FIGS. 1, 2 and 3, according to a first embodiment of the present disclosure, the interface unit 150 may be mounted on a Printed Circuit Board (PCB) 140, and may include five metal terminals. In particular, according to the first embodiment of the present disclosure, the electric power terminal 151 may include a first electric terminal 151a and a second electric terminal 151b. The first electric power terminal 151a and the second electric power terminal 151b are electrically separated.

According to the first embodiment of the present disclosure, the electric overstress preventing unit 180 may be a resistor 180a which is interposed between the first electric power terminal 151a and the second electric power terminal 151b to connect the first electric power terminal 151a to the second electric power terminal 151b in series. The first electric power terminal 151a may be connected to an end of the resistor 180a, and the second electric power terminal 151b may be connected to the other end of the resistor 151b. The resistor 180a may be mounted on the printed circuit board 140. According to various embodiments of the present disclosure, a potential voltage of the resistor 180a may be determined considering a magnitude of the electric overstress. According to various embodiments of the present disclosure, the electric overstress preventing unit 180 may be formed of an inductor, or a combination of the resistor and the inductor, which may be serially connected to the first electric power terminal 151a and the second electric power terminals 151b.

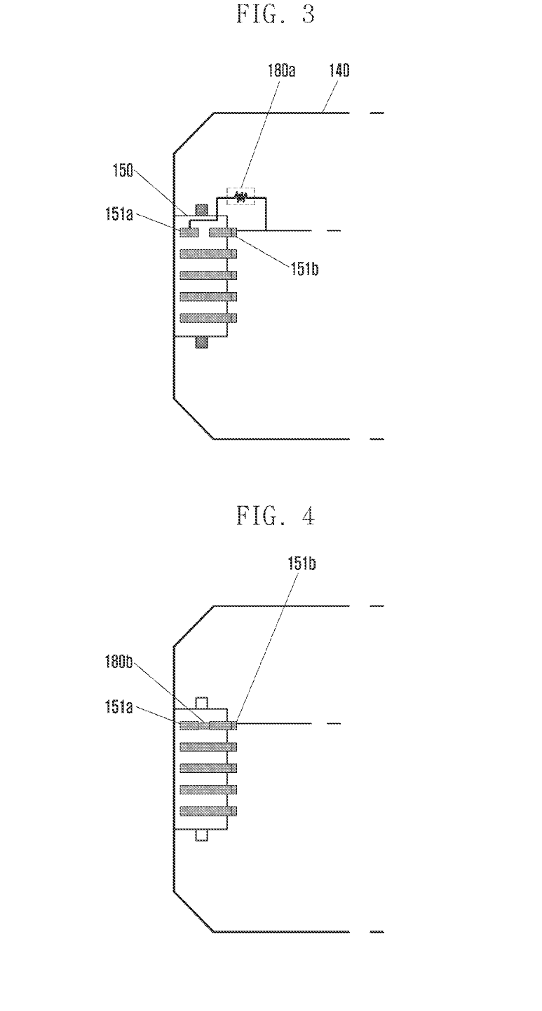

FIG. 4 is a detailed view illustrating an interface unit and an electric overstress preventing unit according to a second embodiment of the present disclosure.

Referring to FIGS. 1, 2, 3 and 4, according to a second embodiment of the present disclosure, the interface unit 150 may be identical to the interface unit 150 according to the first embodiment of the present disclosure as described above. According to a second embodiment of the present disclosure, the electric overstress preventing unit 180 may be formed of a metal terminal 180b with a width narrower than a width of the first electric power terminal 151a and the second electric power terminal 151b. The configuration of the metal terminal 180b, specifically the width of the metal terminal 180b uses a characteristic in that resistance of the metal terminal 180b increases as the metal terminal has a narrower width. For example, according to the second embodiment of the present disclosure, the width of the metal terminal interposed between the first electric power terminal 151a and the second electric power terminal 151b is reduced so as to provide an effect similar to the serial resistor such as the resistor included in the first embodiment of the present disclosure. According to various embodiments of the present disclosure, the widths of the first electric power terminal 151a and the second electric power terminal 151b may be changed according to a maximum charging electric current. For example, in the case that the maximum charging electric current is 1A, the first electric power terminal 151a and the second electric power terminal 151b have a width of about 1 mm, while in the case that the maximum charging electric power is 2A, the first electric power terminal 151a and the second electric power terminal 151b may have a width of about 2 mm.

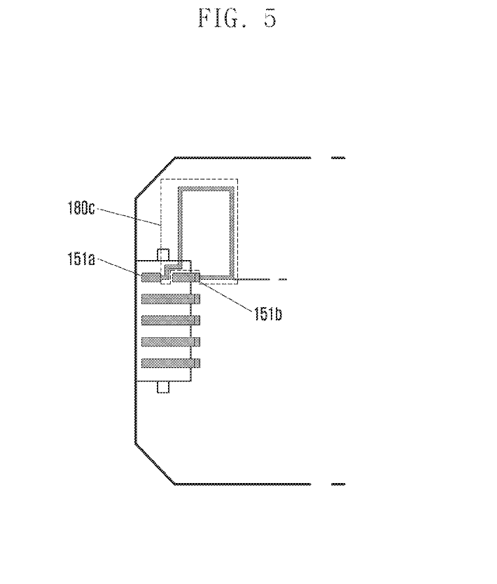

FIG. 5 is a detailed view illustrating an interface unit and an electric overstress preventing unit according to a third embodiment of the present disclosure.

Referring to FIGS. 1, 2, 3, 4 and 5, according to a third embodiment of the present disclosure, the interface unit 150 may be identical to the interface unit 150 according to the first and second embodiments of the present disclosure described above. According to third embodiment of the present disclosure, the electric overstress preventing unit 180 may be formed of a metal terminal 180c which has a width narrower than the width of the first electric power terminal 151a and the second electric power terminal 151b, and extends onto the printed circuit board 140. This is to use a characteristic of the metal terminal in that the resistance of the metal terminal increases as the metal terminal has a decreased width and an increased length. For example, the third embodiment of the present disclosure may be used in the case that sufficiently increasing the resistance by only reducing the width of the metal terminal is difficult, as in the second embodiment of the present disclosure.

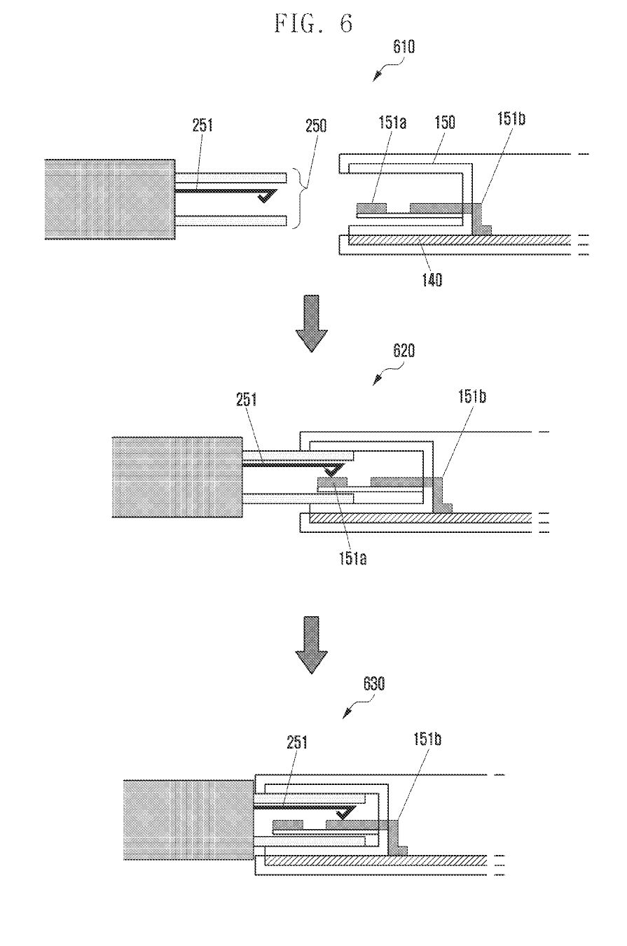

FIG. 6 is a view illustrating a connection of an interface unit of an external device with an interface unit of an electronic device according to an embodiment of the present disclosure.

Referring to FIGS. 1 to 6, the interface unit 250 of the charger 200 may include an electric power pin 251. The electric power pin 251 may have elasticity. The interface unit 150 of the electronic device 100 is mounted on the printed circuit board 140, and may include a first electric power terminal 151a and a second electric power terminal 151b.

Referring to FIG. 6, a reference numeral 610 indicates a state of the electronic device 100 and the charger 200 before the electronic device 100 is connected to the charger 200. In the state as indicated by the reference numeral 610, when the interface unit 250 of the charger 200 is partially inserted into the interface unit 150 of the electronic device 100 as indicated by a reference numeral 620 in FIG. 6, the electric power pin 251 may contact the first electric power terminal 151a of the electronic device 100. At this time, the electric power of the charger 200 may be supplied to the charging unit 190 through the first electric power terminal 151a, the electric overstress preventing unit 180 and the second electric power terminal 151b.

If the interface unit 250 of the charger 200 is completely inserted into the interface unit 150 of the electronic device 100 as indicated by a reference numeral 630 in FIG. 6, then the electric power pin 251 may contact the second electric power terminal 151a of the electronic device 100. At this time, the electric power of the charger 200 may be supplied to the charging unit 190 through the electric power pin 251 and the second electric power terminal 151b.

As described above, in the electronic device 100 according to various embodiments of the present disclosure, electric power of the charger 200 is not directly supplied to the charging unit 190 until the charger 200 is completely inserted in the electronic device 100, but supplied to the charging unit 190 after passing the electric overstress preventing unit 180. Accordingly, the electronic device 100 according to various embodiments of the present disclosure may protect the charging unit 190 from the electric overstress temporarily generated when the charger 200 is connected to the electronic device 100.

The case of protecting the charging unit from the electric overstress generated when the charger is connected to the interface unit of the electronic device has been described up to now as an example of the present disclosure. However, various embodiments of the present disclosure are not limited thereto. For example, the present disclosure may be applied to a case that various electronic parts (e.g., Power Management Integrated Circuit (PMIC)), in the electronic device to which the electric power of the charger or the external electric power supply device is directly connected are protected from the electric overstress generated when the charger or the external electric power supply device is connected to the electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for preventing an electric overstress in an electronic device which includes an interface unit for connecting the electronic device to an external device, the apparatus comprising:
an electric power terminal which is included in the interface unit, and includes a first electric power terminal and a second electric power terminal which are electrically separated; and
an electric overstress preventing unit connected with the first electric power terminal and the second electric power terminal.

2. The apparatus of claim 1, wherein the electric overstress preventing unit is a resistor interposed between the first electric power terminal and the second electric power terminal and is connected in series with the first electric power terminal and the second electric power terminal.

3. The apparatus of claim 1, wherein the electric overstress preventing unit is formed of a metal terminal having a narrower width than a width of the first electric power terminal and a width of the second electric power terminal, and wherein the electric overstress preventing unit is interposed between the first electric power terminal and the second electric power terminal

4. The apparatus of claim 3, wherein the metal terminal extends onto a printed circuit board.

5. The apparatus of claim 1, further comprising:
a charging unit which is supplied with electric power from the external device so as to charge a battery,
wherein the electric power of the external device is supplied to the charging unit through the first electric power terminal, the electric overstress preventing unit, and the second electric power terminal when the interface unit of the external device is partially inserted into the interface unit of the electronic device.

6. The apparatus of claim 5, wherein, when the interface unit of the external device is completely inserted into the interface unit of the electronic device, the electric power of the external device is directly supplied to the charging unit through the second electric power terminal.

7. An electronic device comprising:
an interface unit to which a charger is connected and which includes a first electric power terminal, a second electric power terminal, and a ground terminal which are electrically separated;
an electric overstress preventing unit connected with the first electric power terminal and the second electric power terminal; and
a charging unit connected with the second electric power terminal.

8. The electronic device of claim 7, wherein the electric overstress preventing unit is a resistor interposed between the first electric power terminal and the second electric power terminal and is connected in series with the first electric power terminal and the second electric power terminal.

9. The electronic device of claim 7, wherein the electric overstress preventing unit is formed of a metal terminal having a narrower width than a width of the first electric power terminal and the second electric power terminal, and wherein the electric overstress preventing unit is interposed between the first electric power terminal and the second electric power terminal.

10. The electronic device of claim 9, wherein the metal terminal extends onto a printed circuit board.

11. The electronic device of claim 7, wherein the electric power of the charger is supplied to the charging unit through the first electric power terminal, the electric overstress preventing unit, and the second electric power terminal when the interface unit of the charger is partially inserted into the interface unit of the electronic device.

12. The electronic device of claim 11, wherein, when the interface unit of the external device is completely inserted into the interface unit of the electronic device, the electric power of the charger is directly supplied to the charging unit through the second electric power terminal.

13. The apparatus of claim 1, wherein the electric overstress preventing unit is configured to limit at least one of the electric voltage and the electric current provided to the electronic device when the interface unit is operatively connected to the external device.

14. The apparatus of claim 13, wherein the overstress preventing unit is configured to reduce at least one of the electric voltage and the electric current provided to the electronic device when the interface unit is operatively connected to the external device.

15. The apparatus of claim 1, wherein the electric overstress preventing unit is configured to moderate at least one of bounce, chatter, and inrush current relating to the connection of the interface unit and external device when the interface unit is operatively connected to the external device.

16. The electronic device of claim 7, wherein the electric overstress preventing unit is configured to limit at least one of the electric voltage and the electric current provided to the electronic device when the interface unit is operatively connected to the charger.

17. The electronic device of claim 16, wherein the overstress preventing unit is configured to reduce at least one of the electric voltage and the electric current provided to the electronic device when the interface unit is operatively connected to the charger.

18. The electronic device of claim 7, wherein the electric overstress preventing unit is configured to moderate at least one of bounce, chatter, and inrush current relating to the connection of the interface unit and charger when the interface unit is operatively connected to the charger.
